(19) United States
(12) Patent Application Publication
(10) Pub. No.: US 2017/0312707 A1
(43) Pub. Date: Nov. 2, 2017

(54) GAS-LIQUID MIXING AND DISTRIBUTING DEVICE, AND SHELL AND TUBE TYPE HEAT EXCHANGER

(71) Applicant: SAMSUNG ENGINEERING CO., LTD., Seoul (KR)

(72) Inventor: Jong Heon PARK, Namyangju-si, Gyeonggi-do (KR)

(21) Appl. No.: 15/525,427

(22) PCT Filed: Jun. 10, 2015
(86) PCT No.: PCT/KR2015/005812

§ 371 Date: May 9, 2017

(30) Foreign Application Priority Data
Nov. 14, 2014 (KR) 10-2014-0158737

(51) Int. Cl. B01F 3/04; B05B 1/00; B01F 5/20; B05B 7/04; F28D 7/10; F28F 9/02

(52) U.S. Cl. CPC B01F 3/04985; F28D 7/103; F28F 9/028; B01F 5/20; B05B 7/0483; B05B 1/005; F28F 2230/00

(57) ABSTRACT

Disclosed herein is a gas-liquid mixing and distributing device. The gas-liquid mixing and distributing device includes a mixing head including a chamber, a plurality of gas spray nozzles, and a plurality of liquid spray nozzles; and a liquid supplying part connected to the mixing head and supplying a liquid to the mixing head, wherein the plurality of gas spray nozzles and the plurality of liquid spray nozzles included in the mixing head are uniformly mixed and distributed so that the liquid and gas sprayed from the mixing head are uniformly mixed with each other.

### TECHNICAL FIELD

The present invention relates to a gas-liquid mixing and distributing device, and a shell and tube type heat exchanger, and more particularly, to a shell and tube type heat exchanger that is vertically installed and a gas-liquid mixing and distributing device that mixes fluids of two phases of gas and liquid and injects the mixed fluid into tubes of the shell and tube type heat exchanger.

### BACKGROUND ART

A heat exchanger collectively refers to a device that transfers heat from a high temperature fluid to a low temperature fluid through a heat transfer wall. The heat exchanger may be classified into a heater, a cooler, an evaporator, and a condenser depending on the usage purpose and function thereof, and may be classified into a double tube type, a shell and tube type, a plate type, and other special type heat exchanger, among which the shell and tube type heat exchanger is most widely used.

The shell and tube type heat exchanger is widely used in refinery and petrochemical plants, and may be used to perform a heat exchange for a high temperature reactor effluent and a low temperature gas-liquid mixing fluid with each other in a reaction loop such as for example, aromatic reforming, trans-alkilation reaction, isomerization reaction, and naphtha, jet-oil, diesel oil hydro desulfurization reaction to recover waste heat from the high temperature reactor effluent.

When a mixing fluid of two phases of gas and liquid is injected into tubes in the above described shell and tube type heat exchanger, the uniform distribution and injection of the gas and the liquid into each tube at the same rate is critical to ensure heat transfer performance, hydraulic performance, and mechanical stability of the heat exchanger.

However, due to a hydraulic characteristics difference caused by a density difference between the gas and the liquid, there is a difference in a mixing ratio of the gas and the liquid injected into each tube, and a surge phenomenon often occurs in which the liquid irregularly flows.

When such phenomenon occurs, there is a deviation in a temperature difference and a film coefficient between a fluid flowing inside each tube and a fluid flowing outside thereof, and there is also a deviation in a tube metal temperature of each tube.

Such deviation not only degrades the heat transfer performance of the heat exchanger and increases pressure loss, but also a thermal expansion difference due to the tube metal temperature difference causes excessive stress on a tube bundle and an expansion joint, which leads to a decrease in the mechanical stability and a device lifespan.

In addition, when the surge occurs in which the liquid intermittently and irregularly flows, the effluent of the heat exchanger and the metal temperature of the tube are irregularly and suddenly fluctuated within predetermined amplitude, and such sudden fluctuation not only impairs process stability, but also significantly shortens the device lifespan.

Meanwhile, the above described problems also exist in a conventionally used shell and tube type heat exchanger into which a gas-liquid fluid is injected. Referring to FIG. 1, a conventional shell and tube type heat exchanger uses a method in which no device for uniformly injecting the gas and the liquid at the same ratio into the tube is installed (FIG. 1A), or a method in which a perforated plate is installed below a tube sheet to partially improve a distribution ratio of the gas/liquid injected into the tube (FIG. 1B). However, the perforated plate may not basically prevent a liquid deflection phenomenon due to momentum of a high density liquid, and also may not prevent a surge phenomenon accompanied by a liquid slip phenomenon due to a density difference and gravity. In particular, as the heat exchanger becomes larger according to an enlargement of a production process and an increase in a heat recovery rate, a gas and liquid non-uniform distribution and the surge phenomenon cause various problems.

In order to solve these problems, a method in which the perforated plate is installed below the tube sheet and the liquid is injected directly onto the perforated plate (FIG. 1C) was used, but this method may not prevent the phenomenon in which the liquid is concentrated in the center.

Therefore, in the case of a large heat exchanger in which the mixing fluid of the two phases of gas and liquid is injected toward the tube, a welded plate type heat exchanger was used in the industry, which is expensive and inconvenient in maintenance instead of the shell and tube type heat exchanger.

### DISCLOSURE

### Technical Problem

An object of the present invention is to provide a gas-liquid mixing and distributing device that uniformly mixes gas and liquid, uniformly distributes the mixed fluid, and injects the distributed fluid into a plurality of tubes of a shell and tube type heat exchanger, and the shell and tube type heat exchanger using the same.

### Technical Solution

According to an exemplary embodiment of the present invention, a gas-liquid mixing and distributing device may include a mixing head including a chamber, a plurality of gas spray nozzles, and a plurality of liquid spray nozzles; and a liquid supplying part connected to the mixing head and supplying a liquid to the mixing head, wherein the plurality of gas spray nozzles and the plurality of liquid spray nozzles included in the mixing head are uniformly mixed and distributed so that the liquid and gas sprayed from the mixing head are uniformly mixed with each other.

The plurality of gas spray nozzles may spray a gas supplied from a gas supplying part of a shell and tube type heat exchanger in which the gas-liquid mixing and distributing device is installed, and a gas-liquid mixing fluid that the gas and the liquid are mixed with each other may be supplied to a tube through a tube sheet of the shell and tube type heat exchanger.

The plurality of gas spray nozzles may be formed as a tube type nozzle that penetrates through the chamber, and the plurality of liquid spray nozzles may be formed as an orifice nozzle formed in a top plate of the chamber.

The mixing head may further include a liquid stack pulverizing nozzle for pulverizing a liquid stack stacked on a region connected to the liquid supplying part of a top plate of the chamber.

The mixing head may include a plurality of columns including the plurality of gas spray nozzles and the plurality of liquid spray nozzles, respectively, and the liquid spray nozzle included in an odd-numbered column of the plurality of columns and the liquid spray nozzle included in an even-numbered column may be formed to have liquid spraying directions opposite to each other.

The liquid supplying part may be implemented in a manifold form including a liquid supplying main pipe and a plurality of liquid supplying branching pipes connected to the liquid supplying main pipe to supply the liquid to the mixing head.

The plurality of gas spray nozzles may be formed as a tube nozzle that penetrates through the chamber, and the plurality of liquid spray nozzles may be formed as an orifice nozzle formed in a wall of each of the plurality of gas spray nozzles of tube type.

The mixing head and the liquid supplying part may be sliding-coupled to each other so that the mixing head is movable in a vertical direction depending on thermal expansion or contraction of the tubes of the shell and tube type heat exchanger.

According to another exemplary embodiment of the present invention, a shell and tube type heat exchanger may include: a plurality of tubes installed within a shell; a lower tube sheet to which one end of the tube is coupled; a lower head having a partition formed therein so that a gas-liquid mixing fluid is supplied toward the lower tube sheet and the tubes; a gas-liquid mixing and distributing device having a mixing head installed within the lower head and generating the gas-liquid mixing fluid; and a gas supplying part supplying a gas to be used in the gas-liquid mixing and distributing device, wherein the gas-liquid mixing and distributing device includes: a mixing head including a chamber, a plurality of gas spray nozzles, and a plurality of liquid spray nozzles; and a liquid supplying part connected to the mixing head and supplying a liquid to the mixing head, wherein the plurality of gas spray nozzles and the plurality of liquid spray nozzles included in the mixing head are uniformly mixed and distributed so that the liquid and gas sprayed from the mixing head are uniformly mixed with each other.

The lower head may have a truncated cone shape of which an upper end area is wider than a lower end area.

When supply pressure of the liquid supplying part is greater than preset pressure, the mixing head may be installable on a lower end region of the lower head, and when the supply pressure of the liquid supplying part is smaller than the preset pressure, the mixing head may be installable on an intermediate end region of the lower head.

The heat exchanger may perform a heat exchange between an injected high temperature fluid and the gas-liquid mixing fluid to recover waste heat from the high temperature fluid.

A sealing ring may be formed on the lower end region of the lower head, wherein the sealing ring may minimize leakage of the gas supplied from the gas supplying part through a gap with the mixing head installed on the lower end region of the lower head.

A plurality of liquid spray nozzles may be formed in a side of the mixing head, wherein the plurality of liquid spray nozzles may spray the liquid toward the gas leaked through the gap.

### Advantageous Effects

According to the various exemplary embodiments of the present invention described above, the gas-liquid mixing and distributing device is installed in the shell and tube type heat exchanger, whereby the heat transfer performance may be improved and device cost may be reduced.

In addition, the gas-liquid mixing and distributing device is installed in the shell and tube type heat exchanger, whereby mechanical stability and process stability problems of the heat exchanger caused by a gas-liquid phase maldistribution may be solved, and the welded plate type heat exchanger that is expansive and inconvenient in maintenance may be replaced with the shell and tube type heat exchanger that is cheap and convenient in maintenance.

### DESCRIPTION OF DRAWINGS

FIGS. 1A to 1C are views illustrating a shell and tube type heat exchanger according to the related art.

FIGS. 2A and 2B are structure views schematically illustrating a shell and tube type heat exchanger according to various exemplary embodiments of the present invention.

FIGS. 3A and 3B are structure views illustrating a gas-liquid mixing and distributing device according to an exemplary embodiment of the present invention.

FIGS. 4A and 4B are structure views illustrating a gas-liquid mixing and distributing device according to another exemplary embodiment of the present invention.

FIGS. 5A and 5B are structure views illustrating a gas-liquid mixing and distributing device according to still another exemplary embodiment of the present invention.

FIGS. 6A and 6B are structure views illustrating a gas-liquid mixing and distributing device according to still another exemplary embodiment of the present invention.

FIG. 7 is a structure view illustrating, in detail, a gas-liquid mixing and distributing device and a sealing ring structure of a high speed spray type shell and tube type heat exchanger according to an exemplary embodiment of the present invention.

FIG. 8 is a structure view illustrating, in detail, a gas-liquid mixing and distributing device and a structure of a sliding joint of a low speed spray type shell and tube type heat exchanger according to an exemplary embodiment of the present invention.

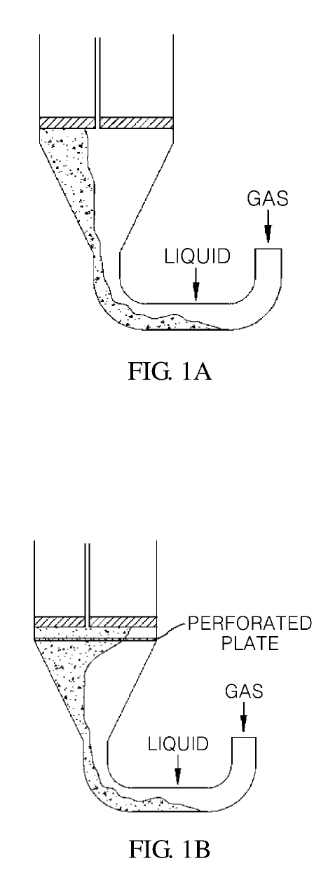

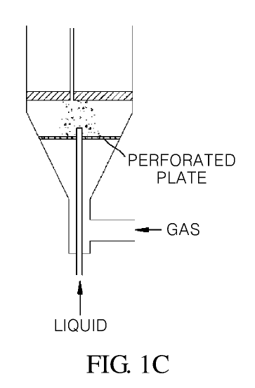

### BEST MODE

Hereinafter, various exemplary embodiments of the present invention will be described in detail with reference to the accompanying drawings.

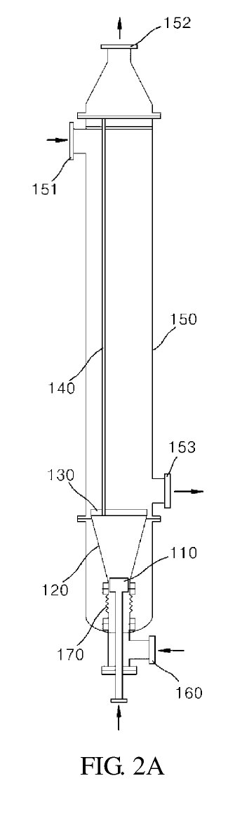

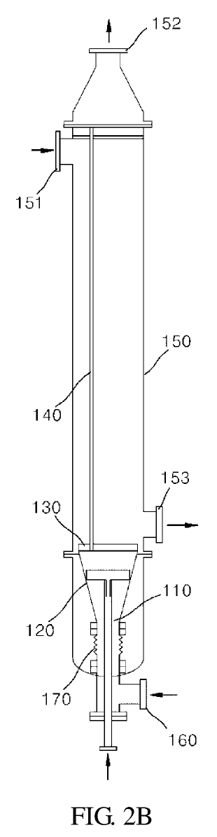

FIGS. 2A and 2B are structure views schematically illustrating a shell and tube type heat exchanger according to various exemplary embodiments of the present invention. Referring to FIGS. 2A and 2B, a shell and tube type heat exchanger 100 according to various exemplary embodiments of the present invention may be classified into a high speed spray type shell and tube type heat exchanger 100-1 and a low speed spray type shell and tube type heat exchanger 100-2 depending on a liquid spray speed.

That is, in the case in which a liquid supply pressure of a liquid supplying part 111 of the gas-liquid mixing and distributing device 110 is greater than a preset pressure, and a liquid spray speed of a liquid spray nozzle 112-3 is thus fast, the shell and tube type heat exchanger 100 may be classified into the high speed spray type shell and tube type heat exchanger 100-1.

In addition, in the case in which the liquid supply pressure of the liquid supplying part 111 of the gas-liquid mixing and distributing device 110 is smaller than the preset pressure, and the liquid spray speed of the liquid spray nozzle 112-3 is thus slow, the shell and tube type heat exchanger 100 may be classified into the low speed spray type shell and tube type heat exchanger 100-2.

Referring to the high speed spray type shell and tube type heat exchanger 100-1 of FIG. 2A and the low speed spray type shell and tube type heat exchanger 100-2 of FIG. 2B, basic components may be the same except for an installation structure of the gas-liquid mixing and distributing device 110.

Specifically, referring to FIGS. 2A and 2B, the high speed spray type shell and tube type heat exchanger 100-1 and the low speed spray type shell and tube type heat exchanger 100-2 may include an injection part 151 into which a high temperature fluid such as a high temperature reactor effluent is injected, a first discharging part 153 from which the high temperature fluid such as a high temperature reactor effluent is discharged, a second discharging part 152 from which a gas-liquid mixing fluid is discharged, a shell 150 on which the injection part 151 and the second discharging part 152 are formed, a plurality of tubes 140 installed within the shell 150, a lower tube sheet 130 to which one end of the tube 140 is coupled, a lower head 120 having a partition formed therein so that the gas-liquid mixing fluid is supplied toward the lower tube sheet 130 and the tube 140, a gas-liquid mixing and distributing device generating the gas-liquid mixing fluid, an expansion joint 170 that is expansible and contractible according to a thermal expansion or contraction of the plurality of tubes 140, and a gas supplying part 160 supplying a gas to be used to the gas-liquid mixing and distributing device 110.

Here, the lower head 120 may have a truncated cone shape of which an upper end area is wider than a lower end area, and a mixing head 112 of the gas-liquid mixing and distributing device 110 may be installed within the lower head 120.

However, a position at which the mixing head 112 of the gas-liquid mixing and distributing device 110 may be installed within the lower head 120 may be differ depending on the high speed spray type shell and tube type heat exchanger 100-1 and the low speed spray type shell and tube type heat exchanger 100-2.

Specifically, as illustrated in FIG. 2A, the mixing head 112 of the gas-liquid mixing and distributing device 110 of the high speed spray type shell and tube type heat exchanger 100-1 may be installed in a lower end region of the lower head 120.

In the case in which the liquid supply pressure is not sufficient, however, in order to decrease pressure loss (i.e., spray speed) of the injection liquid, the liquid spray nozzle of the low speed spray type shell and tube type heat exchanger 100-2 may be designed to have a much larger diameter than the high speed spray type shell and tube type heat exchanger 100-1, as illustrated in FIG. 2B. In addition, as illustrated in FIG. 2B, the mixing head 112 of the gas-liquid mixing and distributing device 110 of the low speed spray type shell and tube type heat exchanger 100-2 may be installed in an intermediate end region of the lower head 120 that is close to the lower tube sheet 130.

Therefore, the low speed spray type shell and tube type heat exchanger 100-2 may secure a wider spray nozzle installation area than the high speed spray type shell and tube type heat exchanger 100-1, and is installed to be closer to the lower tube sheet 130 than the high speed spray type shell and tube type heat exchanger 100-1 so that the gas-liquid mixing fluid may directly arrive at an inlet of each tube without being separated.

Such shell and tube type heat exchanger 100 may perform a heat exchange between a high temperature fluid such as the injected high temperature reactor effluent and the gas-liquid mixing fluid generated by the gas-liquid mixing and distributing device 110 with each other and thus recover waste heat from the high temperature fluid.

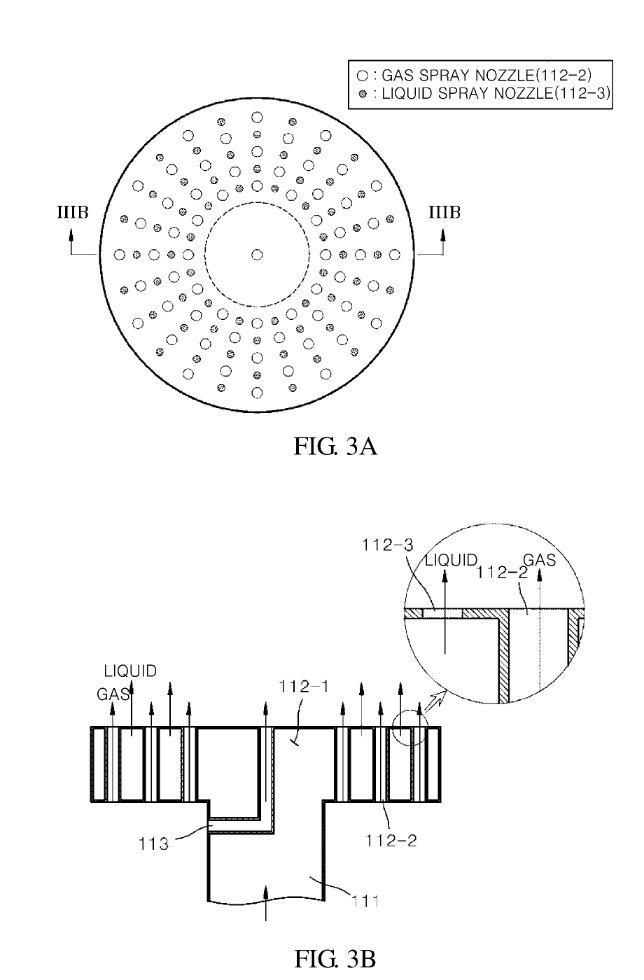

Hereinafter, the gas-liquid mixing and distributing device 110 used in the high speed spray type shell and tube type heat exchanger 100-1 and the low speed spray type shell and tube type heat exchanger 100-2 described above will be described in detail with reference to FIGS. 3A to 6B.

FIG. 3A is a plan view illustrating a gas-liquid mixing and distributing device according to an exemplary embodiment of the present invention, and FIG. 3B is a cross-sectional view taken along IIIB-IIIB of the gas-liquid mixing and distributing device according to an exemplary embodiment of the present invention.

Referring to FIGS. 3A and 3B, the gas-liquid mixing and distributing device 110 may include a mixing head 112 including a chamber 112-1, a plurality of gas spray nozzles 112-2, and a plurality of liquid spray nozzles 112-3, and a liquid supplying part 111 connected to the mixing head 112 to supply a liquid to the mixing head 112.

Here, the plurality of gas spray nozzles 112-2 may be formed as a tube type nozzle that penetrates through the chamber 112-1, and the plurality of liquid spray nozzles 112-3 may be formed as an orifice nozzle formed in a top plate of the chamber 112-1.

The plurality of gas spray nozzles 112-2 and the plurality of liquid spray nozzles 112-3 that are formed in the mixing head 112 may be distributed to be uniformly mixed so that the liquid and the gas sprayed from the mixing head 112 are uniformly mixed with each other.

Specifically, the mixing head 112 may include a plurality of columns including the plurality of gas spray nozzles 112-2 and the plurality of liquid spray nozzles 112-3, respectively. For example, in the case in which the top plate of the mixing head 112 is implemented in a circular shape, the plurality of gas spray nozzles 112-2 and the plurality of liquid spray nozzles 112-3 may be included in each of a first column corresponding to a first concentric circle having a first radius to an n-th column corresponding to an n-th concentric circle having an n-th radius.

In this case, the gas spray nozzle 112-2 and the liquid spray nozzle 112-3 may be sequentially positioned in each of the columns, and different nozzles 112-2 and 112-3 may be positioned in adjacent regions of the respective nozzles 112-2 and 112-3. For example, the liquid spray nozzle 112-3 may be positioned in the adjacent region of the gas spray nozzle 112-3, and the gas spray nozzle 112-2 may be positioned in the adjacent region of the liquid spray nozzle 112-3.

In the case in which the gas-liquid mixing and distributing device 110 according to the present invention is installed in the high speed spray type shell and tube type heat exchanger as illustrated in FIG. 2A, since the injected gas and liquid are sprayed through the plurality of nozzles 112-2 and 112-3 that are uniformly mixed and distributed, the gas and the liquid may be mixed at the same time of the spraying, and the gas and the liquid may be secondarily mixed with each other by a gas inhalation/mixing effect by an ejector principle of the liquid that is sprayed at high speed and strong turbulence caused by the high speed liquid.

In addition, in the case in which the gas-liquid mixing and distributing device 110 according to the present invention is installed in the low speed spray type shell and tube type heat exchanger as illustrated in FIG. 2B, since the injected gas and liquid are sprayed through the plurality of nozzles 112-2 and 112-3 that are uniformly mixed and distributed, the gas and the liquid may be mixed at the same time of the spraying, and there is no mixing effect of the gas and the liquid by the ejector effect of the liquid that is sprayed at high speed and the turbulence effect, but the gas and the liquid may be secondarily mixed with each other by the turbulence effect caused by the gas that is sprayed at relatively faster speed.

Meanwhile, the gas-liquid mixing fluid generated by the gas-liquid mixing and distributing device 110 may be supplied to the plurality of tubes 140 through the lower tube sheet 130 of the shell and tube type heat exchanger 100.

Meanwhile, the mixing head 112 may further include a liquid stack pulverizing nozzle 113 for pulverizing a liquid stack stacked on a region connected to the liquid supplying part 111 of the top plate of the chamber 112-1.

Specifically, since the tube type gas spray nozzle that vertically penetrates through the chamber 112-1 may not be installed in the portion (e.g., a central portion of a circular shape in FIG. 3) to which the liquid supplying part 111 is connected, the liquid spray nozzle 112-3 may not also be installed. In this case, a liquid stack having an unstable cone shape may be stacked on the top plate of the chamber 112-1 in which the gas and liquid spray nozzles 112-2 and 112-3 are not arranged.

In this case, the liquid stack pulverizing nozzle 113 may grind the liquid stack by injecting the gas into the stacked liquid stack.

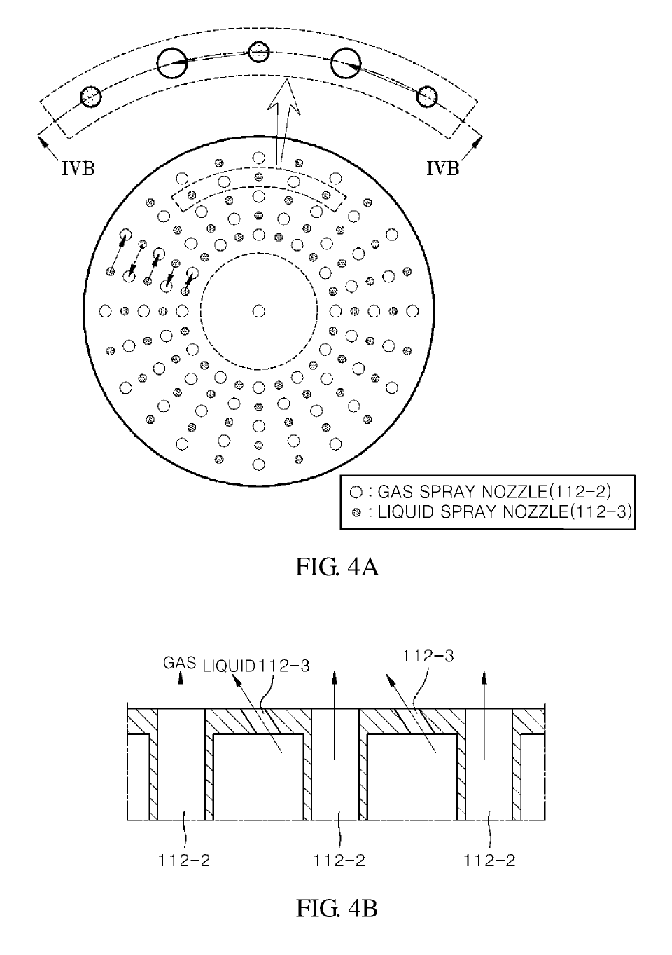

Meanwhile, according to another exemplary embodiment of the present invention, the gas-liquid mixing and distributing device 110 may be formed in a structure as illustrated in FIGS. 4A and 4B. Specifically, FIG. 4A is a plan view illustrating a gas-liquid mixing and distributing device according to another exemplary embodiment of the present invention, and FIG. 4B is a cross-sectional view taken along IVB-IVB of the gas-liquid mixing and distributing device according to another exemplary embodiment of the present invention.

Referring to FIGS. 4A and 4B, the gas-liquid mixing and distributing device 110 according to another exemplary embodiment of the present invention may be differ from the structure of the gas-liquid mixing and distributing device of FIGS. 3A and 3B, in that it has a structure that the liquid spray nozzle 112-3 sprays the liquid toward the gas spray nozzle 112-2.

In this case, the structure may be formed so that a liquid spraying direction of the liquid spray nozzle 112-3 included in an even-numbered column and a liquid spraying direction of the liquid spray nozzle 112-3 included in an odd-numbered column are opposite to each other.

Specifically, the mixing head 112 may include the plurality of columns that each include the plurality of gas spray nozzles 112-2 and the plurality of liquid spray nozzles 112-3, and in this case, the liquid spray nozzle 112-3 included in the odd-numbered column of the plurality of columns may spray the liquid in a first tangential direction, and the liquid spray nozzle 112-3 included in the even-numbered column of the plurality of columns may spray the liquid in a second tangential direction that is a direction opposite to the first tangential direction.

According to the present invention described above, when the spraying directions of the liquid spray nozzles 112-3 arranged in odd and even numbered concentric circles are opposite to each other, fluid rotation directions are opposite to each other in the odd and even numbered concentric circles, such that mixing efficiency may be maximized while a deflection phenomenon of the liquid due to centrifugal force may be minimized.

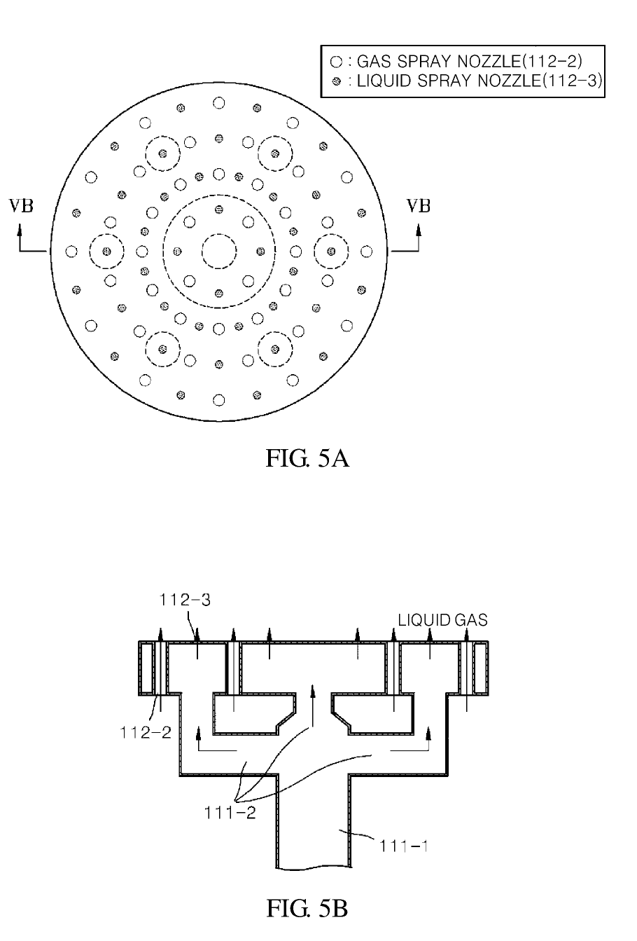

Meanwhile, according to still another exemplary embodiment of the present invention, the gas-liquid mixing and distributing device 110 may be formed in a structure as illustrated in FIGS. 5A and 5B. Specifically, FIG. 5A is a plan view illustrating a gas-liquid mixing and distributing device according to still another exemplary embodiment of the present invention, and FIG. 5B is a cross-sectional view taken along VB-VB of the gas-liquid mixing and distributing device according to still another exemplary embodiment of the present invention.

Referring to FIGS. 5A and 5B, the gas-liquid mixing and distributing device 110 according to still another exemplary embodiment of the present invention may be differ from the structure of the gas-liquid mixing and distributing device of FIGS. 3A to 4B, in that the liquid supplying part 111 has a structure of manifold form.

Specifically, the liquid supplying part 111 may be implemented in the manifold form including a liquid supplying main pipe 111-1 and a plurality of liquid supplying branch pipes 111-2 connected to the liquid supplying main pipe to supply the liquid to the mixing head 112.

According to the present invention described above, since the liquid supplying part 111 may be connected to various portions of the chamber 112-1, the gas-liquid spray nozzles 112-2 and 112-3 may be efficiently arranged.

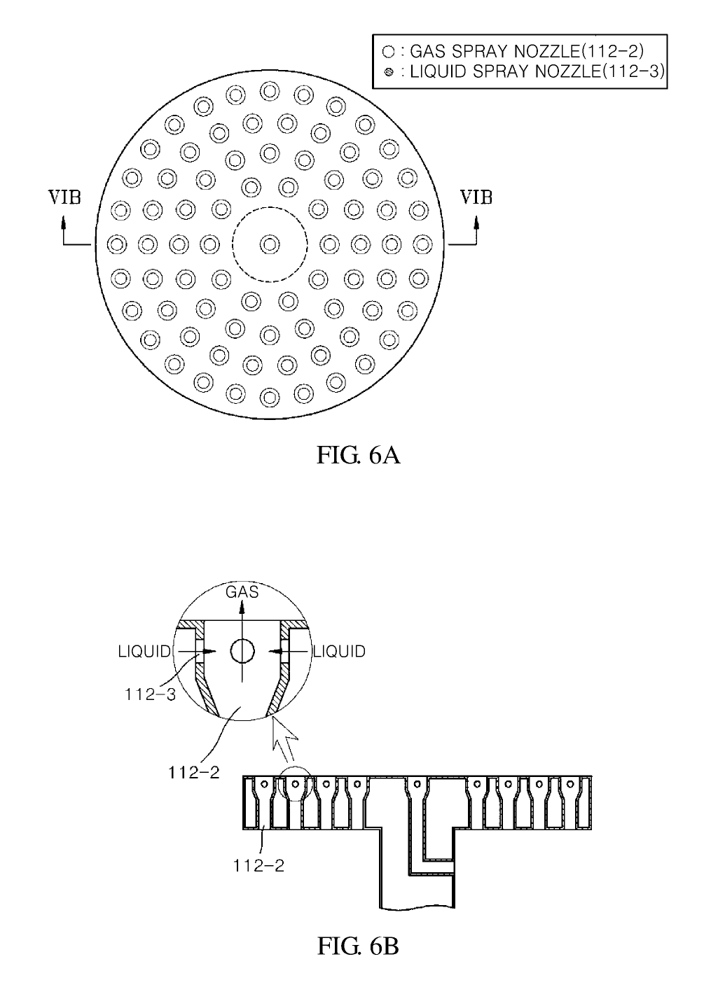

Meanwhile, according to still another exemplary embodiment of the present invention, the gas-liquid mixing and distributing device 110 may be formed in a structure as illustrated in FIGS. 6A and 6B. Specifically, FIG. 6A is a plan view illustrating a gas-liquid mixing and distributing device according to still another exemplary embodiment of the present invention, and FIG. 6B is a cross-sectional view taken along VIB-VIB of the gas-liquid mixing and distributing device according to still another exemplary embodiment of the present invention.

Referring to FIGS. 6A and 6B, the gas-liquid mixing and distributing device 110 according to still another exemplary embodiment of the present invention may be differ from the structure of the gas-liquid mixing and distributing device of FIGS. 3A to 5B, in that it has a structure that the plurality of liquid spray nozzles 112-3 are formed in a side wall of each of the plurality of gas spray nozzles 112-2 to mix the gas and the liquid with each other in the gas spray nozzle 112-2 and discharge the mixed gas and liquid.

Specifically, the plurality of gas spray nozzles 112-2 may be formed as a tube type nozzle that penetrates through the chamber, and the plurality of liquid spray nozzles 112-3 may be formed as an orifice nozzle formed in the side wall of each of the plurality of tube type gas spray nozzles 112-2.

Meanwhile, this is merely one example of the present invention, and according to another exemplary embodiment of the present invention, an upper diameter of the gas spray nozzle 112-2 of the tube form may be expanded to reduce pressure loss of the gas and the liquid, and the liquid spray nozzle 112-3 may be bored in the expanded upper diameter.

The gas-liquid mixing and distributing device 110 according to still another exemplary embodiment of the present invention described above may be more useful when it is installed in the low speed spray type shell and tube type heat exchanger 100-2 as illustrated in FIG. 2B. Specifically, the low speed spray type shell and tube type heat exchanger 100-2 has an advantage that it secures a wide nozzle installation area, but has a disadvantage that gas-liquid mixing efficiency is decreased due to an increase in an installation interval of the gas spray nozzle 112-2 and the liquid spray nozzle 112-3. According to the present invention, however, the above-mentioned problem may be solved by mixing the gas and the liquid with each other within the gas spray nozzle 112-2 and discharging the mixed gas and liquid.

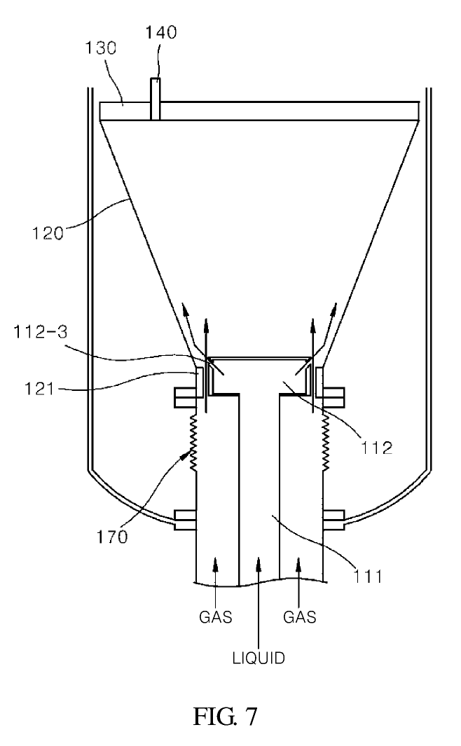

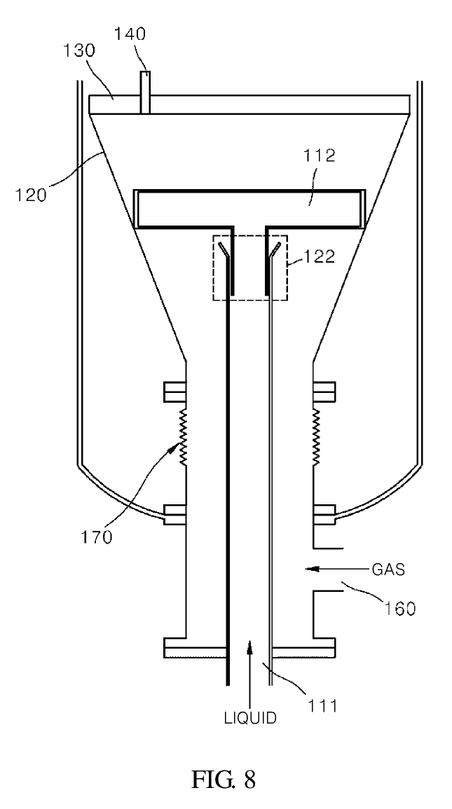

Hereinafter, the structure of the high speed spray type shell and tube type heat exchanger 100-1 and the low speed spray type shell and tube type heat exchanger 100-2 described above will be described in detail with reference to FIGS. 7 and 8.

FIG. 7 is a structure view illustrating, in detail, a high speed spray type shell and tube type heat exchanger according to an exemplary embodiment of the present invention. Referring to FIG. 7, the high speed spray type shell and tube type heat exchanger 100-1 may include a sealing ring 121 installed on the lower end region of the lower head 120 and minimizing leakage of gas supplied from the gas supplying part 160 through a gap between the mixing head 112 and the lower region of the lower head 120.

Specifically, in order to efficiently mix the gas and liquid with each other by the high speed spray type gas-liquid mixing and distributing device 110, the gap between the mixing head 112 and the lower region of the lower head 120 is made as small as possible to minimize the leakage of the gas through the gap between the mixing head 112 and the lower end region of the lower head 120. However, since in order to install the mixing head 112 in the lower end region of the lower head 120, the mixing head need to penetrate through the expansion joint 170 having an internal diameter smaller than the lower end region of the lower head 120 there is a limitation in narrowing the gap by increasing an external diameter of the mixing head 112. According to the present invention, however, it is possible to minimize the leakage of the gas supplied from the gas supplying part 160 through the gap between the mixing head 112 and the lower end region of the lower head 120 using the sealing ring 121.

Meanwhile, although the sealing ring 121 is installed, the leakage of the gas through the gap may not be perfectly prevented.

Therefore, according to an exemplary embodiment of the present invention, the plurality of liquid spray nozzles 112-3 for spraying the liquid toward the gas leaked through the gap may be formed in the side of the mixing head 112. According to the present invention described above, the liquid is sprayed to the gas leaked through the gap, such that a gas-liquid mixture having the same mixing ratio as the gas-liquid mixture sprayed by the upper nozzle of the mixing head 112 may be made.

FIG. 8 is a structure view illustrating, in detail, a low speed spray type shell and tube type heat exchanger according to an exemplary embodiment of the present invention. Referring to FIG. 8, the low speed spray type shell and tube type heat exchanger 100-2 may be installed on an intermediate end region of the lower head 120. In addition, the mixing head 112 and the liquid supplying part 111 may be sliding-coupled 122 to each other so that the mixing head 112 is vertically movable depending on thermal expansion or contraction of the tubes 140 of the low speed spray type shell and tube type heat exchanger 100-2.

Specifically, since the mixing head 112 of the high speed spray type shell and tube type heat exchanger 100-1 is positioned on the lower end region of the lower head 120, it has a structure that the mixing head 112 is movable in a vertical direction depending on the thermal expansion or contraction of the tubes 140.

However, since the mixing head 112 of the low speed spray type shell and tube type heat exchanger 100-2 is attached to the intermediate end region of the lower head 120 and the liquid supplying part 111 is attached to the shell 150, it has a structure that the mixing head 112 is not freely movable in the vertical direction depending on the thermal expansion or contraction of the tubes 140.

Therefore, according to the present invention, the mixing head 112 and the liquid supplying part 111 may be sliding-coupled 122 to each other by installing a pipe having an external diameter slightly smaller than an internal diameter of the liquid supplying part 111 below the mixing head 112, and inserting the pipe into the liquid supplying part 111. In this case, the gap may be designed as small as possible to minimize the leakage of the gas or the leakage of the liquid into or from the gap between the sliding coupling 122. Accordingly, the mixing head 112 of the low speed spray type shell and tube type heat exchanger 100-2 may be movable in the vertical direction depending on the thermal expansion or contraction of the tubes (140).

Meanwhile, in the case in which the sliding coupling 122 described above is formed, the liquid supplying part 111 of the manifold form FIGS. 5A and 5B may be attached and installed onto an upper portion of the liquid supplying part 111 of the sliding coupling 122 and a lower portion of the chamber 112-1.

Meanwhile, according to the various exemplary embodiments of the present invention described above, while it has illustrated that the gas is sprayed through the tube type nozzle and the liquid is sprayed through the orifice nozzle, the present invention is not limited thereto. For example, in a process condition in which a gas weight flow rate is much smaller than a liquid weight flow rate, the positions of the gas and liquid spray nozzles may be interchanged to facilitate the design/manufacturing and the arrangement of the spray nozzles. That is, the design may be made so that the gas is sprayed through the orifice nozzle of the top plate of the chamber, and the liquid is sprayed through the tube type nozzle that penetrates through the chamber. In this case, a liquid stack pulverizing orifice hole having the same purpose instead of the liquid stack pulverizing nozzle 113 illustrated in FIGS. 3A and 3B may be installed on the center of the top plate of the chamber 112-1. In addition, the liquid supplying part 111 supplying the liquid to be used in the gas-liquid mixing and distributing device 110 may be replaced with the gas supplying part supplying the gas, and the gas supplying part 160 supplying the gas to be used in the gas-liquid mixing and distributing device 110 may be replaced with the liquid supplying part supplying the liquid.

Although exemplary embodiments of the present invention have been illustrated and described hereinabove, the present invention is not limited to the above-mentioned specific exemplary embodiments, but may be variously modified by those skilled in the art to which the present invention pertains without departing from the scope and spirit of the present invention as disclosed in the accompanying claims. These modifications should also be understood to fall within the scope of the present invention.

1. A gas-liquid mixing and distributing device, comprising:
a mixing head including a chamber, a plurality of gas spray nozzles, and a plurality of liquid spray nozzles; and
a liquid supplying part connected to the mixing head and supplying a liquid to the mixing head,
wherein the plurality of gas spray nozzles and the plurality of liquid spray nozzles included in the mixing head are uniformly mixed and distributed so that the liquid and gas sprayed from the mixing head are uniformly mixed with each other.

2. The gas-liquid mixing and distributing device of claim 1, wherein the plurality of gas spray nozzles spray a gas supplied from a gas supplying part of a shell and tube type heat exchanger in which the gas-liquid mixing and distributing device is installed, and
gas-liquid mixing fluid that the gas and the liquid are mixed with each other is supplied to tubes through a tube sheet of the shell and tube type heat exchanger.

3. The gas-liquid mixing and distributing device of claim 2, wherein the plurality of gas spray nozzles are formed as a tube type nozzle that penetrates through the chamber, and
the plurality of liquid spray nozzles are formed as an orifice nozzle formed in a top plate of the chamber.

4. The gas-liquid mixing and distributing device of claim 2, wherein the mixing head further includes a liquid stack pulverizing nozzle for pulverizing a liquid stack stacked on a region connected to the liquid supplying part of a top plate of the chamber.

5. The gas-liquid mixing and distributing device of claim 3, wherein the mixing head includes a plurality of columns including the plurality of gas spray nozzles and the plurality of liquid spray nozzles, respectively, and
the liquid spray nozzle included in an odd-numbered column of the plurality of columns and the liquid spray nozzle included in an even-numbered column are formed to have liquid spraying directions opposite to each other.

6. The gas-liquid mixing and distributing device of claim 2, wherein the liquid supplying part is implemented in a manifold form including a liquid supplying main pipe and a plurality of liquid supplying branching pipes connected to the liquid supplying main pipe to supply the liquid to the mixing head.

7. The gas-liquid mixing and distributing device of claim 2, wherein the plurality of gas spray nozzles are formed as a tube nozzle that penetrates through the chamber, and
the plurality of liquid spray nozzles are formed as an orifice nozzle formed in a wall of each of the plurality of gas spray nozzles of tube type.

8. The gas-liquid mixing and distributing device of claim 2, wherein the mixing head and the liquid supplying part are sliding-coupled to each other so that the mixing head is movable in a vertical direction depending on thermal expansion or contraction of the tubes of the shell and tube type heat exchanger.

9. A shell and tube type heat exchanger, comprising:
a plurality of tubes installed within a shell;
a lower tube sheet to which one end of the tube is coupled;
a lower head having a partition formed therein so that a gas-liquid mixing fluid is supplied toward the lower tube sheet and the tubes;
a gas-liquid mixing and distributing device having a mixing head installed within the lower head and generating the gas-liquid mixing fluid; and
a gas supplying part supplying a gas to be used in the gas-liquid mixing and distributing device,
wherein the gas-liquid mixing and distributing device includes:
a mixing head including a chamber, a plurality of gas spray nozzles, and a plurality of liquid spray nozzles; and
a liquid supplying part connected to the mixing head and supplying a liquid to the mixing head,
wherein the plurality of gas spray nozzles and the plurality of liquid spray nozzles included in the mixing head are uniformly mixed and distributed so that the liquid and gas sprayed from the mixing head are uniformly mixed with each other.

10. The shell and tube type heat exchanger of claim 9, wherein the lower head has a truncated cone shape of which an upper end area is wider than a lower end area.

11. The shell and tube type heat exchanger of claim 10, wherein when supply pressure of the liquid supplying part is greater than preset pressure, the mixing head is installable on a lower end region of the lower head, and
when the supply pressure of the liquid supplying part is smaller than the preset pressure, the mixing head is installable on an intermediate end region of the lower head.

12. The shell and tube type heat exchanger of claim 9, wherein the heat exchanger performs a heat exchange between an injected high temperature fluid and the gas-liquid mixing fluid to recover waste heat from the high temperature fluid.

13. The shell and tube type heat exchanger of claim 11, wherein a sealing ring is formed on the lower end region of the lower head, the sealing ring minimizing leakage of the gas supplied from the gas supplying part through a gap with the mixing head installed on the lower end region of the lower head.

14. The shell and tube type heat exchanger of claim 13, wherein a plurality of liquid spray nozzles are formed in a side of the mixing head, the plurality of liquid spray nozzles spraying the liquid toward the gas leaked through the gap.

15. A gas-liquid mixing and distributing device, comprising:
a mixing head including a chamber, a plurality of gas spray nozzles, and a plurality of liquid spray nozzles; and
a gas supplying part connected to the mixing head and supplying a gas to the mixing head,
wherein the plurality of gas spray nozzles and the plurality of liquid spray nozzles included in the mixing head are uniformly mixed and distributed so that the liquid and gas sprayed from the mixing head are uniformly mixed with each other.

16. The gas-liquid mixing and distributing device of claim 15, wherein the plurality of liquid spray nozzles are formed as a tube type nozzle that penetrates through the chamber, and
the plurality of gas spray nozzles are formed as an orifice nozzle formed in a top plate of the chamber.
